(19) United States
(12) Patent Application Publication
(10) Pub. No.: US 2025/0360659 A1
(43) Pub. Date: Nov. 27, 2025

(54) Methods for Compensating for Optical Surface Nonuniformity

(71) Applicant: DigiLens Inc., Sunnyvale, CA (US)

(72) Inventors: Jonathan David Waldern, Diablo, CA (US); Shibu Abraham, Sunnyvale, CA (US); Milan Momcilo Popovich, Leicester (GB)

(73) Assignee: DigiLens Inc., Sunnyvale, CA (US)

(21) Appl. No.: 19/292,824

(22) Filed: Aug. 6, 2025

Related U.S. Application Data
(63) Continuation of application No. 18/457,227, filed on Aug. 28, 2023, now Pat. No. 12,397,477.
Application No. 18/457,227 is a continuation of application No. 16/783,019, filed on Feb. 5, 2020, now abandoned.
(60) Provisional application No. 62/801,528, filed on Feb. 5, 2019.

(51) Int. Cl. B29C 35/08; G02B 6/12; G02F 1/13; G02F 1/1334

(52) U.S. Cl. CPC B29C 35/0805; G02F 1/1326; G02F 1/1334; B29C 2035/0827; G02B 2006/12166

(57) ABSTRACT

Systems and methods for compensating for nonuniform surface topography features in accordance with various embodiments of the invention are illustrated. One embodiment includes a method for manufacturing waveguide cells, the method including providing a waveguide including first and second substrates and a layer of optical recording material, and applying a surface forming process to at least one external surface of the first and second substrates. In another embodiment, applying the surface forming process includes applying a forming material coating to the at least one external surface, providing a forming element having a forming surface, bringing the forming element in physical contact with the forming material coating, curing the forming material coating while it is in contact with the forming element, and releasing the forming material coating from the forming element.

### CROSS-REFERENCE TO RELATED APPLICATIONS

The current application is a continuation of U.S. patent application Ser. No. 18/457,227, entitled “Methods for Compensating for Optical Surface Nonuniformity”, filed Aug. 28, 2023 and published as US 2024-0217142 A1 on Jul. 4, 2024, which is a continuation of U.S. patent application Ser. No. 16/783,019 entitled “Methods for Compensating for Optical Surface Nonuniformity,” filed Feb. 5, 2020 and published as US 2020-0247017 A1 on Aug. 6, 2020, which application claims the benefit of and priority under 35 U.S.C. § 119 (e) to U.S. Provisional Patent Application No. 62/801,528 entitled “Methods for Compensating for Optical Surface Nonuniformity,” filed Feb. 5, 2019. The disclosures of which are hereby incorporated by reference in their entirety.

### FIELD OF THE INVENTION

The present invention generally relates to methods for compensating for nonuniform surface topography features in substrates and, more specifically, in waveguide substrates.

### BACKGROUND

Surface flatness is a common requirement in the manufacture of various semiconductor devices, including but not limited to display backplanes. In holographic waveguides used for conveying image data, tight planarity tolerances are desirable to avoid image artifacts that can result from light path deviations caused by surface nonuniformities. Industry methods for planarization of semiconductor substrates include low pressure chemical vapor deposition (LPCVD), etch-back of a sacrificial layer (typically a photoresist), simultaneous etch and deposition, chemical mechanical polishing (CMP), reflow of SiO₂ doped with phosphorus and boron glass, and other processes. Applications of such methods cover the range from smooth partial planarization all the way to complete global planarization. Existing processes of relevance to the manufacture of holographic waveguides can include organic spin coating, molding using a planar surface, and other coating processes.

### SUMMARY OF THE INVENTION

Systems and methods for compensating for nonuniform surface topography features in accordance with various embodiments of the invention are illustrated. One embodiment includes a method for manufacturing waveguide cells, the method including providing a waveguide including first and second substrates and a layer of optical recording material, and applying a surface forming process to at least one external surface of the first and second substrates.

In another embodiment, applying the surface forming process includes applying a forming material coating to the at least one external surface, providing a forming element having a forming surface, bringing the forming element in physical contact with the forming material coating, curing the forming material coating while it is in contact with the forming element, and releasing the forming material coating from the forming element.

In a further embodiment, the surface forming process provides surface planarization the at least one external surface.

In still another embodiment, applying the surface forming process further includes depositing at least one of a release layer or a hard coat layer.

In a still further embodiment, curing the forming material coating includes applying UV curing radiation via a curing configuration selected from the group consisting of one or more UV sources distributed above the forming material coating, a fixture including UV sources spatially distributed around the waveguide, and one or more UV sources coupled into an internal reflection path within at least one of the forming element or the waveguide.

In yet another embodiment, curing the forming material coating includes a curing configuration selected from the group consisting of applying radiation having more than one wavelength, applying UV radiation having more than one wavelength within the UV spectrum, applying a thermal process, applying pressure, immersing the forming material coating in a vacuum, immersing the forming material coating in a gas, immersing the forming material coating in a liquid, applying radiation having a wavelength within the visible spectrum, applying radiation having a wavelength within the infrared spectrum, and exposing the forming material coating to a humid atmosphere.

In a yet further embodiment, the forming material coating includes a material selected from the group consisting of photoresists, resins, polymers, thermosets, thermoplastic polymers, polyepoxies, polyamides, low viscosity planarization materials, materials with viscosity between 10 and 15 cps at 20° C., materials with viscosity below 2 cps at 20° C., and ethylene glycol diacrylate.

In another additional embodiment, the release layer is a fluorocarbon silylating agent.

In a further additional embodiment, the forming surface of the forming element has a surface characteristic for compensating for shrinkage of the forming material coating.

In another embodiment again, the method further includes correcting a wedge characteristic of the forming material coating after completion of the surface forming process.

In a further embodiment again, the first substrate is curved, and the forming element surface has a curvature matching the curvature of the first substrate.

In still yet another embodiment, the forming surface of the forming element has a degree of planarization less than 98%.

In a still yet further embodiment, the first substrate is a plastic.

In still another additional embodiment, the substrates have a birefringence calculated to provide smoothing of non-uniformity after a predefined number of TIR beam reflections.

In a still further additional embodiment, the method further includes employing an apparatus for monitoring at least one selected from the group of thickness, composition, and uniformity of the forming material during deposition.

In still another embodiment again, providing the waveguide includes providing the first substrate, depositing the layer of optical recording material onto the first substrate using at least one deposition head, wherein the optical recording material deposited over a grating region is formulated to achieve a predefined grating characteristic selected from the group consisting of refractive index modulation, refractive index, birefringence, liquid crystal director alignment, grating layer thickness, and a spatial variation of the characteristic, providing the second substrate, placing the second substrate onto the deposited layer of optical recording material, and laminating the first substrate, the layer of optical recording material, and the second substrate.

In a still further embodiment again, providing the waveguide further includes depositing at least one of release layer or a hard coat layer using the at least one deposition head.

In yet another additional embodiment, the forming element is an optical flat, a refractive optical element, or an optical element with at least one optical surface providing optical power.

In a yet further additional embodiment, the forming element is supported by a substrate providing an optical path from a light source for curing.

In yet another embodiment again, the layer of optical recording material includes a polymer dispersed liquid crystal mixture.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 shows a flow diagram conceptually illustrating a method of providing a planarized waveguide in accordance with an embodiment of the invention.

FIGS. 2A-2E conceptually illustrate a series of process steps for planarizing a waveguide in accordance with an embodiment of the invention.

FIG. 3 conceptually illustrates a curing configuration utilizing a curing source disposed above a transparent forming element in accordance with an embodiment of the invention.

FIG. 4 conceptually illustrates a curing configuration utilizing a curing source optically coupled to a forming element in accordance with an embodiment of the invention.

FIG. 5 conceptually illustrates a curing configuration utilizing a curing source optically coupled to a waveguide in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Planarization processes in accordance with various embodiments of the invention includes processes that can enable low cost products and lightweight designs. In many embodiments, a planarization process is implemented for planarizing plastic substrates for use in waveguides. Such processes can be utilized to mitigate or eliminate undesirable surface characteristics of the plastic substrates. Undesirable defects can include wedge shapes, bending of the substrate, and high total thickness variation. In some embodiments, the planarization process is compatible with deposition and printing processes that can be used in the manufacturing of holographic waveguides. Such processes are described in further detail in U.S. application Ser. No. 16/203,071 filed Nov. 28, 2018 entitled “Systems and Methods for Manufacturing Waveguide Cells,” the disclosure of which is hereby incorporated by reference in its entirety for all purposes. In some embodiments, a planarization process is implemented for curved waveguides, which can be integrated into various applications such as but not limited to helmet visors and car windshields. In such cases, the planarization process can compensate for deviations from the desired curvature of the waveguide. In several embodiments, a planarization process is implemented for correcting nonuniformity in waveguides, including curved waveguides. Although planarization processes in accordance with various embodiments of the invention apply to the compensation of surface nonuniformities of waveguide substrates of any geometry, to simplify the description of such embodiments, the discussions below will generally address applications directed at planarizing nominally flat waveguide substrates.

In many embodiments, the planarization process is performed on the outer surfaces of a fabricated waveguide. In some embodiments, the planarization process is performed on a substrate before it is used to fabricate a waveguide. The planarization process can include coating the faces of a waveguide or substrate with a deformable material (referred to as a forming material) and then bringing it into contact with an element (referred to as a forming element) having a forming surface with a desired surface profile, typically a surface with a high degree of flatness. The forming material can be cured, and the outer surfaces of the finished waveguide or substrate can achieve flatness specifications substantially equal to those of the forming surface. The process can be applied to one or both of the external surfaces of the waveguide. In the case of a curved waveguide or substrate, the process can include using a curved forming surface instead of a flat forming surface. In a number of embodiments, the curved forming surface has a curvature matching that of the waveguide or substrate. Waveguide structures, planarization processes, and planarization materials utilized for such processes are described below in further detail.

### Optical Waveguides and Grating Structures

Optical structures recorded in waveguides can include many different types of optical elements, such as but not limited to diffraction gratings. In many embodiments, the grating implemented is a Bragg grating (also referred to as a volume grating). Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

One class of gratings used in holographic waveguide devices is the Switchable Bragg Grating (SBG). SBGs can be fabricated by first placing a thin film of a mixture of photopolymerizable monomers and liquid crystal material between substrates, forming a waveguide cell. Waveguide cells are described in the sections below in further detail. The substrates can be made of various types of materials, such glass and plastics. In many cases, the substrates are in a parallel configuration. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

Waveguides can be constructed using a variety of processes, including but not limited to those described in U.S. application Ser. No. 16/203,071. In many embodiments, the waveguide is fabricated with a grating having a predefined grating characteristic. One manufacturing process capable of fabricating such waveguides includes a deposition technique where a layer of optical recording material is deposited onto a first substrate using at least one deposition head. In some embodiments, the optical recording material is a polymer dispersed liquid crystal mixture. In a number of embodiments, the optical recording material does not include liquid crystals. As can readily be appreciated, any type of recording material can be utilized as appropriate depending on the specific requirements of a given application. The optical recording material deposited over the grating region can be formulated to form a grating having a predefined grating characteristic. In a number of embodiments, the predefined grating characteristic is at least one of: refractive index modulation, refractive index, birefringence, liquid crystal director alignment, grating layer thickness, and combinations thereof. In further embodiments, the grating is formed with a spatially varying predefined grating characteristic. A second substrate can be placed on the deposited layer of optical recording material, and an exposure process can be performed to form gratings within the optical recording material layer.

In some embodiments, LC can be extracted or evacuated from the SBG to provide a surface relief grating (SRG) that has properties very similar to a Bragg grating due to the depth of the SRG structure (which is much greater than that practically achievable using surface etching and other conventional processes commonly used to fabricated SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications.

Waveguides in accordance with various embodiments of the invention can include various grating configurations designed for specific purposes and functions. In many embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field of view, arranged in separate overlapping grating layers or multiplexed in a single grating layer. Furthermore, various types of gratings and waveguide architectures can also be utilized.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field of view of at least 50° diagonal. In further embodiments, the waveguide display can provide an image field of view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4k×4k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both S-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm).

### Planarization Processes

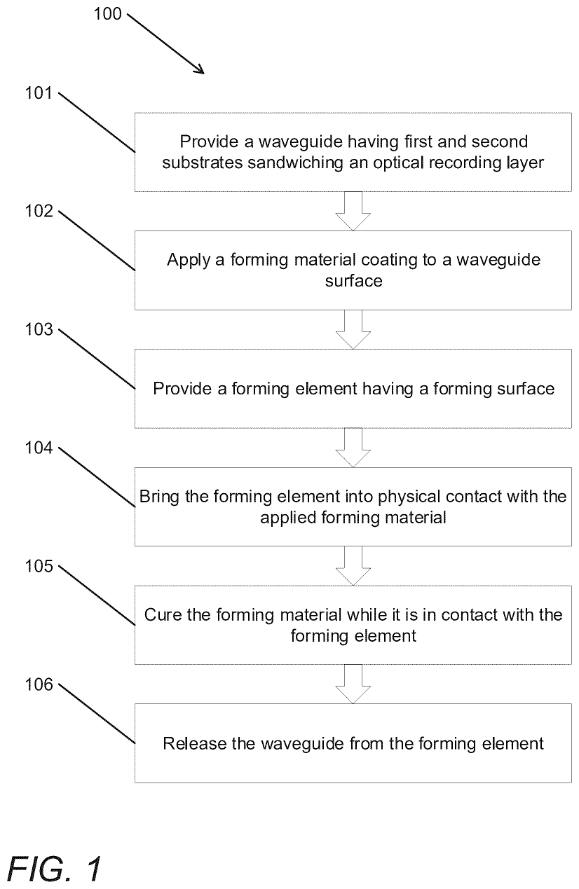

Planarization processes in accordance with various embodiments of the invention can utilize a variety of different types of substrates, including but not limited to glass and plastic substrates of different thicknesses and geometries. Plastic substrates can include but are not limited to polyvinyl butyral (PVB), cyclo-olefinic polymers (COP), polymethyl methacrylate (PMMA), polycarbonates (PC), clear polyimides, etc. In many embodiments, the substrate can be injection molded. In some embodiments, the substrate has low birefringence. In several embodiments, the substrate has a birefringence calculated to provide smoothing of illumination non-uniformities occurring in the finished waveguide in normal operation. The planarization process can be performed on individual substrates or the outer surfaces of constructed waveguides. FIG. 1 shows a flow diagram conceptually illustrating a method of providing a planarized waveguide in accordance with an embodiment of the invention. Referring to the flow diagram, the method 100 includes providing (101) a waveguide having first and second substrates sandwiching a layer of optical recording material. As described above, such waveguides can be manufactured using a variety of different methods. In some embodiments, the layer of optical recording material contains a recorded grating. In other embodiments, the optical recording material is uncured. A forming material can be applied (102) to one or both surfaces of the waveguide. Various types of forming materials and application processes can be utilized. For example, inkjetting, spin coating, dip coating, or any other coating process can be utilized. As can readily be appreciated, the application technique can largely depend on the type of material utilized. Different thicknesses of forming material can be applied as appropriate depending on the application. Depending on the type of material, thicker layers can result in more haze for waveguide operation. In several embodiments, the layer of forming material applied is less than ˜10 μm. In further embodiments, the layer of forming material applied is less than ˜5 μm. A forming element having a forming surface can be provided (103). Various types of forming elements can be utilized. In many embodiments, the forming element can be an optical flat or a more general refractive optical element. The forming element can be brought into physical contact (104) with the forming material. In some embodiment, a process is applied to settle the forming element into a desired position. For example, a vacuum process can be applied to remove air pockets. The forming material can be cured (105) while it is in contact with the forming element. In various embodiments, curing of the planarization material (forming material) can include the application of radiation of one or more wavelengths to the material. In many embodiments, radiation of two or more wavelengths is utilized. In several embodiments, ultraviolet radiation can be used. In some embodiments, infrared radiation or visible band light can be used. Sequential or simultaneous curing steps based on any of the above procedures may be used. Curing can include thermal processes which may include infrared heating. In a number of embodiments, the curing process can include the application of pressure. In some embodiments, curing of the forming material can be carried out in a vacuum, a gas, or in a liquid. The curing process can include exposure to a humid atmosphere. The planarized waveguide can be released (106) from the forming element. In many embodiments, the forming material now includes a surface profile corresponding to the surface of the forming element. In various embodiments, the planarization process does not include the use of a forming element. In such cases, the forming material is cured after it is applied to the substrate or waveguide surface. The forming material can be chosen such that gravity is sufficient for planarization. In a number of embodiments, the forming element contains a previously applied release layer. The coating can be applied using spray coating of polytetrafluoroethylene (PTFE) or similar compounds. In several embodiments, the release coating can be a fluorocarbon silylating agent. To avoid wear of the forming element, a hard coating can be applied to the forming surface of the forming element prior to application of a release coating. In some embodiments, a release coating may be applied to the forming material. Release layers and hard coating layers can be applied using various techniques, including but not limited to printing and coating techniques.

After the curing process, the external surfaces of the waveguides can be coated with a hard coat. In a number of embodiments, the hard coating process replaces the planarization step with the hard coat acting as the forming material. In some embodiments, the hard coat is a liquid resin material or an acrylate. In many embodiments, the hard coat implemented is similar to the ones used to protect plastic lenses. One example of a hard coating material is the Nidek Co., Ltd (Japan) “Acier” hard coating material, which is designed for hard coating lenses and transparent plastic substrates. The coating thickness can vary widely. In some embodiments, the coating thickness is about 30 micrometers. As can readily be appreciated, the precise coating thickness can depend on the average surface non-uniformity and shape. In several embodiments, exposure of the waveguide gratings is carried out after all of the above steps have been completed. In many embodiments, exposure of the waveguide gratings can be carried out before the application of the forming material (or hard coat material). In such cases, it can be desirable that the forming material and the application process are compatible with the waveguide materials. For example, the forming material can be chosen such that its application process occurs at a temperature low enough to prevent any deformation of any formed waveguide gratings. As can readily be appreciated, the choice of forming material can depend on the material within which the waveguide gratings are formed.

In many embodiments, planarization involves the application of a reference flat (made from various materials). In some embodiments, the planarization process can employ apparatus and process steps for controlling the wedge of the planarized surface. In several embodiments, surface flatness can be monitored during the planarization process. In various embodiments, the planarization process can employ an apparatus for monitoring at least one selected from the group of thickness, composition, and uniformity of the forming material during deposition. In a number of embodiments, the forming element can be cut to match the dimensions of the waveguide. In many embodiments, a tool fixture for presenting the working surface of the forming element to the forming material layer can be provided.

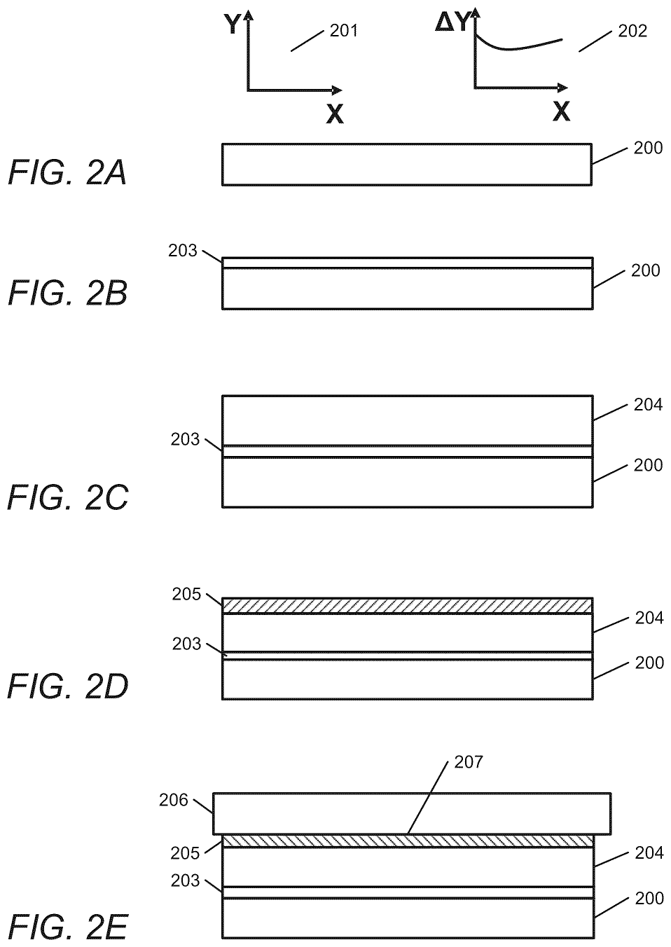

FIGS. 2A-2E conceptually illustrate a series of process steps for planarizing a waveguide in accordance with an embodiment of the invention. FIG. 2A shows a cross section of a first waveguide substrate 200 in the XY plane 201. In the illustrative embodiment, the surface of the substrate 200 has a deviation ΔY in the XY plane 201 from its nominal planar geometry as represented by the plot 202. In typical cases, the deviation ΔY will vary across the surface of the substrate 200. FIG. 2B shows a coating 203 of holographic recording material applied to the first substrate 200. FIG. 2C shows a second substrate 204 placed over the holographic recording material layer 203. FIG. 2D shows a layer of forming material 205 applied over the second substrate 204. As described above, either or both outer surfaces of the waveguide can be sequentially or simultaneously planarized. FIG. 2E shows a forming element 206 with a forming surface 207 applied to the forming material 205. In many embodiments, the forming element has a degree of planarization less than 98% wherein the degree of planarization is defined as [1−(T′/T)]×100% where T is the surface deviation of the untreated surface and T′ is the resulting surface deviation after completion of the planarization process.

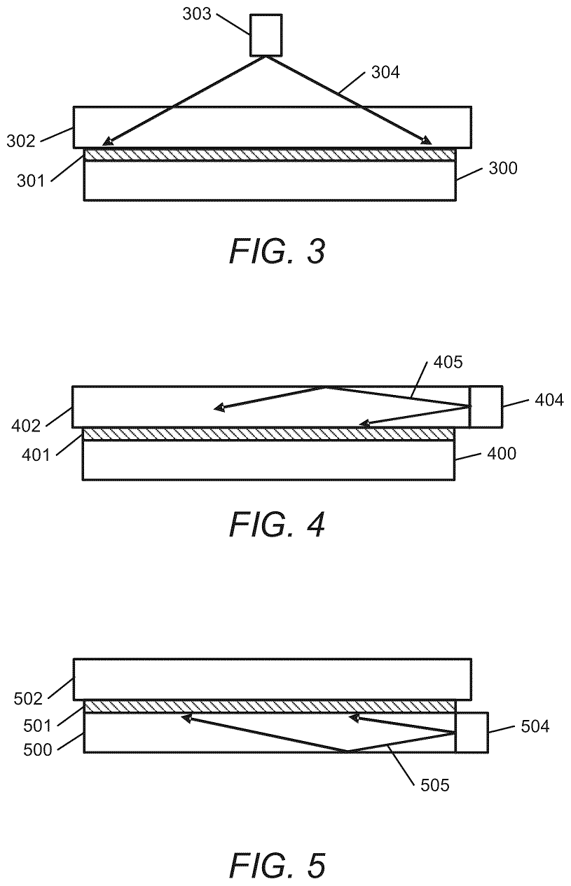

In several embodiments, the forming element is supported by a transparent substrate providing an optical path from one or more sources of curing radiation. In various embodiments, the forming element is a transparent refracting element with at least one surface having optical power for controlling the intensity distribution of the radiation presented to the forming material layer. In many embodiments, the forming element can be an optical flat or a more general refractive optical element. In such embodiments, the curing radiation can be introduced to the forming material via the forming element. In some embodiments, the curing radiation is provided by a group of one or more UV sources distributed above a transparent forming element. FIG. 3 conceptually illustrates a curing configuration utilizing a curing source disposed above a transparent forming element in accordance with an embodiment of the invention. As shown, a waveguide 300 supports a forming material coating 301 that is in contact with a forming element 302. In the illustrative embodiment, a curing source 303 provides curing radiation 304 that is transmitted in a diverging beam via the forming element 302 to irradiate the forming material coating 301. In some embodiments, the curing radiation can be coupled from one or more sources spatially distributed around the forming element into an internal reflection path within the forming element. FIG. 4 conceptually illustrates a curing configuration utilizing a curing source optically coupled to a forming element in accordance with an embodiment of the invention. As shown, a waveguide 400 supports a forming material coating 401 that is in contact with a forming element 402. Curing radiation from a curing source 404 is optically coupled to the waveguide 400 and is introduced to the forming material coating 401 via total internal reflection paths 405. In several embodiments, the curing radiation is provided by sources spatially distributed around the waveguide. FIG. 5 conceptually illustrates a curing configuration utilizing a curing source optically coupled to a waveguide in accordance with an embodiment of the invention. As shown, a waveguide 500 supports a forming material coating 501 that is in contact with a forming element 502. Curing radiation from a curing source 504 is optically coupled to the waveguide 500 and is introduced to the forming material coating 501 via total internal reflection paths 505.

Although FIGS. 1-5 illustrate specific processes for planarizing the surface of substrates and waveguides, such processes can be modified as appropriate depending on the specific requirements of a given application. Modifications of planarization processes in accordance with various embodiments of the invention can include the deletion or addition of various steps. For example, in some embodiments, a forming element is not needed as the forming material is capable of forming a desired flatness profile passively using gravitational forces.

### Planarization Materials

Many different materials can be used to provide a forming or planarization material. For example, photoresists, resins, polymers, thermosets, thermoplastic polymers, polyepoxies, and polyamides may be used. In a number of embodiments, ethylene glycol diacrylate may be used. In many embodiments, the forming material has low shrinkage. Where use of a low shrinkage material is not practical, shrinkage of the planarization material can be compensated by modifying the topography of the forming surface. In some embodiments, low viscosity forming materials may be used. In several embodiments, low viscosity materials with viscosity below 1 cps (centipoise) at 20° C. may be used. In many embodiments, low viscosity materials with viscosity below 2 cps at 20° C. As can readily be appreciated, various materials having a wide range of viscosity can be utilized as appropriate depending on the specific requirements of a given application. For example, in some embodiments, the forming material is applied using deposition/printing techniques such as but not limited to inkjet printing. In such cases, it can be desirable for the material to have a viscosity compatible with the techniques used. In several embodiments, the material has a viscosity between ˜10-˜ 15 cps at 20° C.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for manufacturing a waveguide supporting a surface relief grating, the method comprising:
depositing a layer of a mixture on a substrate, the mixture comprising: a photopolymerizable monomer and a liquid crystal;
exposing the mixture to a holographic recording beam to form a volume phase grating of alternating liquid crystal-rich polymer and liquid crystal-depleted polymer regions;
removing the liquid crystal from the volume phase grating to form the surface relief grating, the surface relief grating comprising alternating polymer and air regions; and
backfilling the air regions within at least a portion of the surface relief grating with a backfill material, wherein the backfill material has a different refractive index than the polymer regions.

2. The method of claim 1, wherein the polymer regions have a higher refractive index than the backfill material.

3. The method of claim 1, wherein the polymer regions have a lower refractive index than the backfill material.

4. The method of claim 1, wherein the liquid crystal-depleted polymer region provides a low-density region, wherein the liquid crystal-depleted polymer region has a lower density than the liquid crystal-rich region.

5. The method of claim 1, wherein removing the liquid crystal from the volume phase grating comprises forming a polymer surface relief grating.

6. The method of claim 1, wherein exposing the mixture to a holographic recording beam phase separates the mixture into a polymer dispersed liquid crystal structure.

7. The method of claim 1, wherein the liquid crystal is removed via flushing with isopropyl alcohol and solvents.

8. The method of claim 1, wherein removing the liquid crystal further comprises surface etching.

9. The method of claim 1, wherein backfilling at least a portion of the surface relief grating comprises depositing the backfill material between the polymer regions using at least one deposition head.

10. The method of claim 1, wherein the backfill material is formulated to achieve a predefined characteristic selected from the group consisting of: efficiency tailoring, angular response, spectral response, polarization, and a spatial variation of the characteristic.

11. The method of claim 1, wherein the substrate has a birefringence specified to provide smoothing of non-uniformity after a predefined number of total internal reflection (TIR) beam reflections.

12. The method of claim 1, wherein depositing the layer of the mixture onto a substrate comprises: depositing said layer of the mixture onto the substrate using at least one deposition head, wherein the mixture deposited over a grating region is formulated to achieve a predefined grating characteristic selected from the group consisting of: refractive index modulation, refractive index, birefringence, liquid crystal director alignment, grating layer thickness, and a spatial variation of the characteristic.

13. The method of claim 1, wherein backfilling at least a portion of the surface relief grating with the backfill material further comprises applying a surface forming process to a surface of the surface relief grating.

14. The method of claim 13, wherein applying the surface forming process comprises:
applying a forming material coating to the surface relief grating;
providing a forming element having a forming surface;
physically contacting the forming element with the forming material coating;
curing the forming material coating while it is in contact with the forming element; and
releasing the forming material coating from the forming element.

15. The method of claim 14, wherein the surface forming process provides surface planarization for the surface relief grating.
